(19) United States
(12) Patent Application Publication
(10) Pub. No.: US 2015/0095543 A1
(43) Pub. Date: Apr. 2, 2015

(54) DATA BUS SYSTEM AND RECORDING APPARATUS

(71) Applicant: Sony Corporation, Tokyo (JP)

(72) Inventors: Takeshi Kubo, Kanagawa (JP); Takeharu Takasawa, Kanagawa (JP); Naofumi Goto, Kanagawa (JP); Seiji Kobayashi, Kanagawa (JP); Kenichi Kawasaki, Tokyo (JP)

(73) Assignee: Sony Corporation, Tokyo (JP)

(21) Appl. No.: 14/494,765

(22) Filed: Sep. 24, 2014

(30) Foreign Application Priority Data
Oct. 1, 2013 (JP) 2013-206643

(51) Int. Cl. G06F 13/40

(52) U.S. Cl. CPC G06F 13/4022
USPC 710/313

(57) ABSTRACT

A data bus system includes a plurality of recording apparatuses, a transmission path, and a management apparatus. The plurality of recording apparatuses are configured to record and hold data. The transmission path is connected to the plurality of recording apparatuses by wireless communication and configured to transmit the data. The management apparatus is configured to manage the plurality of recording apparatuses and the transmission path.

### CROSS REFERENCE TO RELATED APPLICATIONS

This application claims the benefit of Japanese Priority Patent Application JP 2013-206643 filed Oct. 1, 2013, the entire contents of which are incorporated herein by reference.

### BACKGROUND

The present disclosure relates to a data bus system and a recording apparatus.

These days, recording apparatuses each containing a flash semiconductor memory and the like include recording apparatuses called an SD (Secure Digital) card, a USB (Universal Serial Bus) memory, an HDD (Hard Disc Drive) containing a plurality of semiconductor memory chips, an SSD (Solid State Drive) with attachment compatibility, and the like. Those recording apparatuses generally include electric contacts as interfaces for the purpose of communication with external apparatuses (see Japanese Patent Application Laid-open No. Hei 11-126244).

### SUMMARY

Since it is assumed that those recording apparatuses are connected to a network or another apparatus by physical connection such as insertion and removal of connectors, there arises a problem that durability of the connectors exposed to the outside is low. Further, the durability of the connectors against the insertion and removal also has a problem. Additionally, there are problems of static electricity, corrosion of a connector portion, and the like.

When those problems are caused, communication with a network or another apparatus is not available.

In view of such problems, it is desirable to provide a data bus system and a recording apparatus that do not cause failures in communication due to deterioration and the like of a connector.

According to an embodiment of the present disclosure, there is provided a data bus system including a plurality of recording apparatuses, a transmission path, and a management apparatus. The plurality of recording apparatuses are configured to record and hold data. The transmission path is connected to the plurality of recording apparatuses by wireless communication and configured to transmit the data. The management apparatus is configured to manage the plurality of recording apparatuses and the transmission path.

Further, according to another embodiment of the present disclosure, there is provided a recording apparatus including a recording unit, a communication unit, and a memory controller. The recording unit is configured to record and hold data. The communication unit is configured to wirelessly communicate with an external transmission path. The memory controller is configured to control input and output of the data to and from the recording unit.

According to the present disclosure, it is possible to achieve a data bus system that does not cause unavailability of communication due to deterioration and the like of a contact of a connector and does not cause failures in communication.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a configuration of a data bus system;

FIG. 2A is a diagram showing a first outer appearance example of a rack system using the data bus system, and FIG. 2B is a block diagram showing a configuration of the rack system of the first example;

FIG. 3A is a diagram showing a second outer appearance example of the rack system using the data bus system, and FIG. 3B is a block diagram showing a configuration of the rack system of the second example;

FIG. 4 is an outer appearance view of a data center including a plurality of rack systems;

FIG. 5A is a top perspective view of a memory cartridge, and FIG. 5B is a bottom perspective view of the memory cartridge;

FIG. 6 is an exploded perspective view of the memory cartridge;

FIG. 7 is an exploded perspective view of the memory cartridge;

FIGS. 8A and 8B are enlarged views of a connector portion of the memory cartridge;

FIG. 9A is an enlarged view showing a connection state of a connector of the memory cartridge and a connector of a waveguide, and FIG. 9B is a diagram showing a connection state of the memory cartridges and the waveguides;

FIG. 10 is a block diagram showing a configuration of the memory cartridge;

FIG. 11 is a block diagram showing a connection state of the waveguide and memory cartridge;

FIG. 12 is a diagram showing specifications of a TX module and an RX module;

FIG. 13 is a diagram showing configurations of the TX module and the RX module;

FIG. 14 is a diagram showing a second example of the configurations of the TX module and the RX module;

FIG. 15 is a diagram schematically showing communication when using a plurality of frequencies; and

FIG. 16 is a diagram for describing a terminal end of the waveguide.

### DETAILED DESCRIPTION OF EMBODIMENTS

Hereinafter, an embodiment of the present disclosure will be described with reference to the drawings. It should be noted that description is given in the following order.

(1. Embodiment)

(1-1. Configuration of Data Bus System)

(1-2. Configuration of Recording Apparatus)

(1-3. Connection between Bus and Recording Apparatus)

(2. Modified Example)

### 1. Embodiment

### 1-1. Configuration of Data Bus System

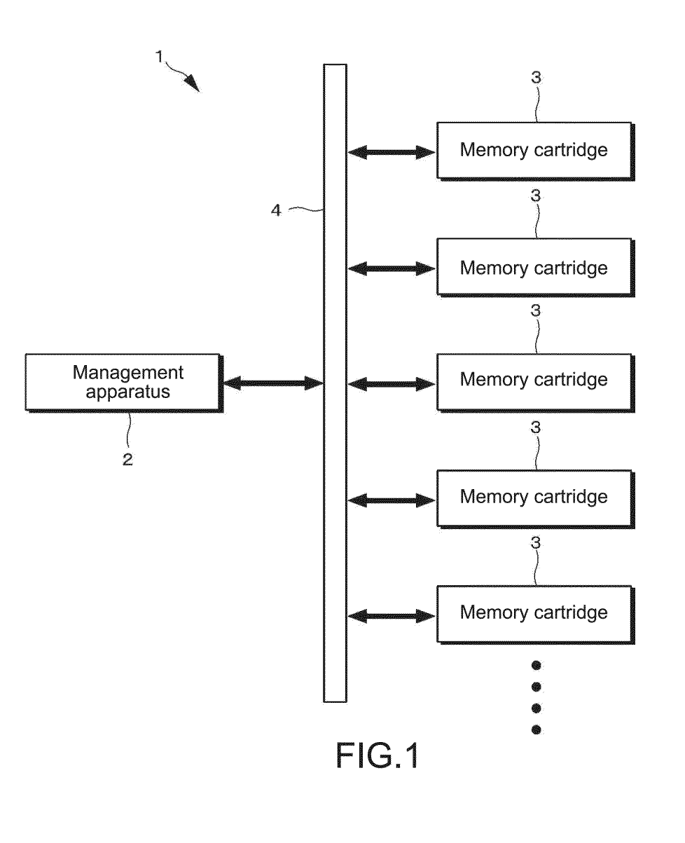

First, description will be given on the configuration of a data bus system 1 according to this embodiment. FIG. 1 is a block diagram showing a configuration of the data bus system 1. The data bus system 1 includes a management apparatus 2, a plurality of memory cartridges 3, 3, 3, . . . , each of which serves as a recording apparatus, and a waveguide 4 serving as a bus.

The management apparatus 2 is an information processing apparatus such as a personal computer including a control unit, a storage unit, an input unit, and the like.

The control unit includes a CPU (Central Processing Unit), a RAM (Random Access Memory), a ROM (Read Only Memory), and the like. The storage unit stores and holds various types of data, programs, and the like. The input unit receives an input from a user.

The ROM stores a program read and operated by the CPU, and the like. The RAM is used as a work memory of the CPU. The CPU executes various types of processing according to a program stored in the ROM and issues commands, to manage and control the management apparatus 2 itself, the whole of the data bus system 1, and each of the memory cartridges 3.

The waveguide 4 as a bus functions as a transmission path between the management apparatus 2 and the plurality of memory cartridges 3. In the present disclosure, communication between the waveguide 4 and the memory cartridges 3 is performed by wireless communication using a microwave band or a millimeter-wave band.

Microwaves are radio waves having a frequency of about 300 MHz to about 300 GHz and a wavelength of about 1 m to 100 μm. Further, millimeter waves are radio waves having a frequency of about 30 to 300 GHz and a wavelength of about 1 to 10 mm. Use of the microwaves or millimeter waves having a high frequency allows wireless communication at a high-speed data rate.

Characteristics of the microwaves or millimeter waves are as follows: because of the short wavelength thereof, downsizing of an antenna or the like is achieved; because of high directivity thereof, the radio waves can be transmitted to only a direction of the other party of communication, and an interference of the radio waves to another direction can be suppressed; and the like. So, it is possible to efficiently perform data communication without interference between devices in a space.

In the present disclosure, the waveguide 4, which is a high-frequency transmission line, is used as a bus. The waveguide is a metallic pipe that has a circular or rectangular cross section and is used for transmitting light, radio waves, and the like. The radio waves propagate in the waveguide while forming an electromagnetic field in the waveguide, the electromagnetic field corresponding to the shape, dimension, or wavelength (frequency) of the waveguide.

The memory cartridge 3 is a cartridge including a built-in flash semiconductor memory capable of recording and holding data and outputting the data to the outside, for example. The memory cartridge 3 communicates with the waveguide 4 serving as a bus by wireless communication using the microwaves or millimeter waves.

The data bus system 1 is configured as described above. The data bus system 1 is used for a system such as a large-scale server, a data center, and a cloud computing data center.

Next, a specific example using the data bus system 1 will be described while taking as an example a rack system used as a data center or the like.

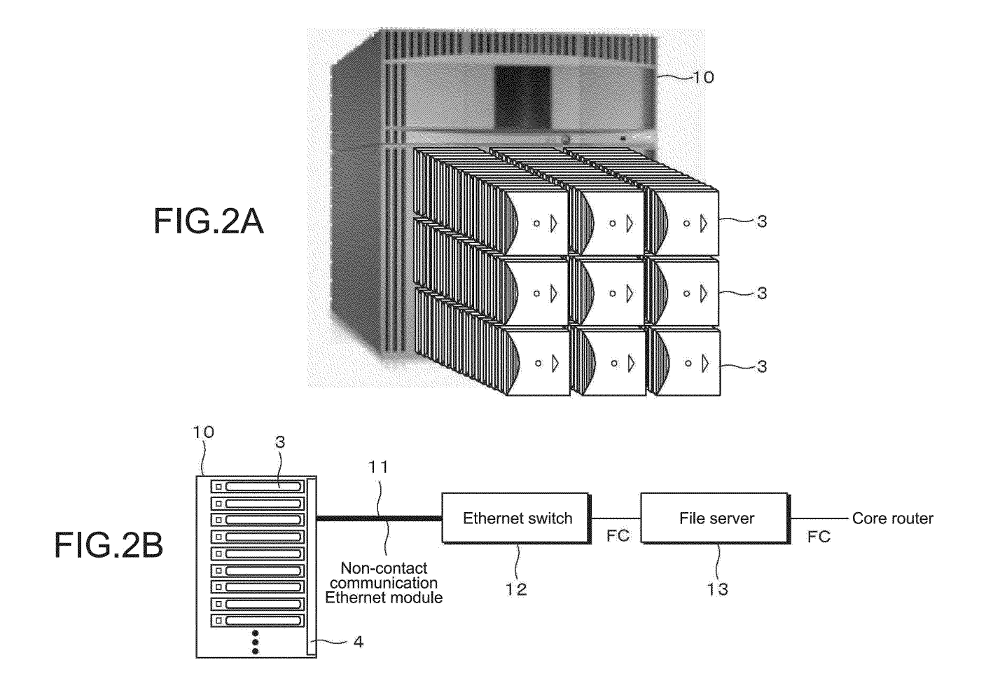

FIG. 2A is a diagram showing a first outer appearance example of a rack system using the data bus system 1. In the example of FIG. 2A, a total of 252 memory cartridges 3, which are arranged in 3 columns by 3 rows at the depth of 28 memory cartridges 3, are accommodated in a rack 10. Note that the number of memory cartridges 3 is merely one example and is not limited to the number described above. The waveguide 4 serving as a bus is provided to the back surface of the rack in a vertical state, for example.

FIG. 2B is a diagram showing a configuration of the rack system using the data bus system 1. The waveguide 4 serving as a bus, which is provided to the back surface or the like of the rack 10, is connected to an Ethernet switch 12 via a non-contact communication Ethernet module 11. The Ethernet switch 12 is a relay device that is connected to an external device in a wired or wireless manner and transmits and receives data. The Ethernet switch 12 is connected to a file server 13 via an FC (Fiber Channel). Further, the file server 13 is connected to a core router via the FC. The core router is a router used for transmitting and relaying data in a core network and used in a large-scale data center, a communication system, and the like.

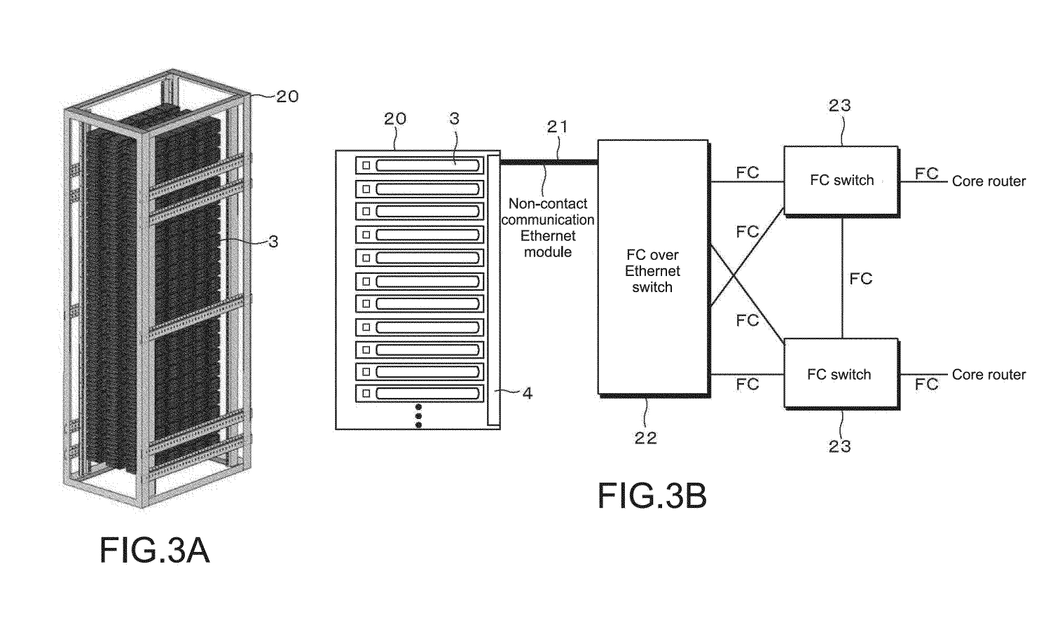

FIG. 3A is a diagram showing a second outer appearance example of the rack system using the data bus system 1. In the example of FIG. 3A, 3 columns each including 414 (252+162) memory cartridges 3 vertically arranged are accommodated side by side in a rack 20. Note that the number of memory cartridges 3 is merely one example and is not limited to the number described above. The waveguide 4 serving as a bus is provided to the back surface of the rack 20 in a vertical state, for example.

FIG. 3B is a diagram showing a configuration of the rack system using the data bus system 1. The waveguide 4 and an Ethernet switch 22 are connected to each other by a non-contact communication Ethernet module 21. The Ethernet switch 22 and FC switches 23 are connected to one another via FCs. Further, the FC switches 23 are connected to core routers via the FCs.

The network in such a rack system is established using a VLAN (Virtual Local Area Network), for example. An IP (Internet Protocol) address is assigned to each of the memory cartridges 3. With use of the IP addresses, a desired memory cartridge can be identified from a large number of memory cartridges 3.

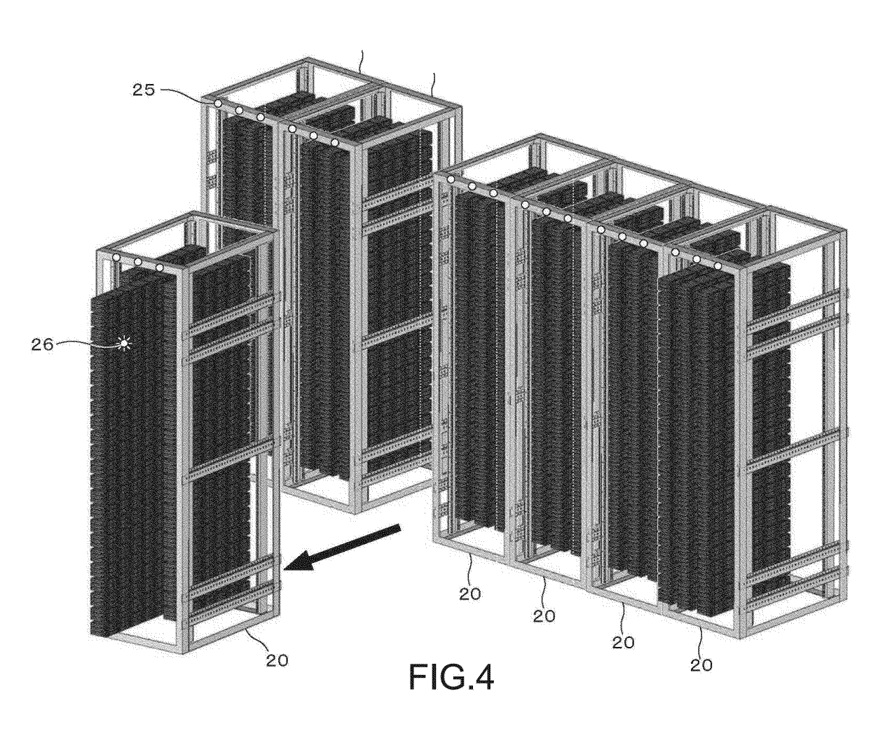

It should be noted that a 19-inch rack is used as the rack, for example. The 19-inch rack is a standardized rack to intensively accommodate a plurality of devices. In the rack, horizontal intervals of screws of a supporting column for attaching devices are determined to be 19 inches. The 19-inch rack is widely used to accommodate a communication device, a video device, an audio device, and the like. Actually, as shown in FIG. 4, a large-scale rack system is established by using a large number of rack systems.

In the case where a large-scale rack system is configured by using a large number of rack systems, since the number of stored memory cartridges 3 is also large, it takes a lot of time and effort to check the statuses of the memory cartridges 3. In this regard, it may be possible to provide a status check alert 25 to the rack as shown in FIG. 4, as a function of periodically inspecting a data holding state and reproduction performance of a non-volatile semiconductor memory 313 accommodated in the memory cartridge 3 and providing a notification of the obtained state to the outside. Additionally, it may be possible to provide a notification alert 26 to the memory cartridge 3 in order to provide a user with a notification on the position of a memory cartridge 3 in a problematic state.

### 1-2. Configuration of Memory Cartridge

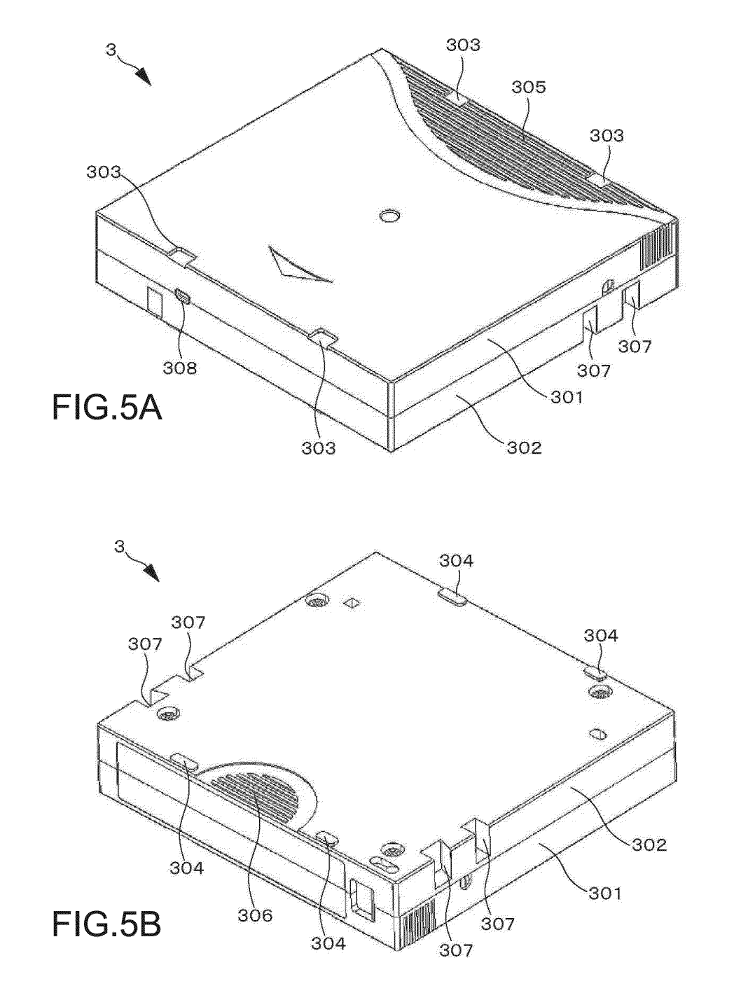

Next, description will be given on the configuration of the memory cartridge 3 serving as a recording apparatus. FIGS. 5A and 5B are views each showing an outer configuration of the memory cartridge 3. FIG. 5A is a top perspective view of the memory cartridge 3 and FIG. 5B is a bottom perspective view thereof.

The memory cartridge 3 is formed into a substantially cuboid shape by an upper case 301 and a lower case 302. A total of 4 stacking positioning concave portions 303 are formed in the front and back of the upper case 301. The stacking positioning concave portions 303 are formed so as to notch ends of the upper case 301. Further, 4 stacking positioning convex portions 304 are provided, in the same quantity as the stacking positioning concave portions 303, to the front and back of a bottom surface of the lower case 302. It should be noted that the number of stacking positioning concave portions 303 and that of stacking positioning convex portions 304 are not limited to four.

The positions of the stacking positioning concave portions 303 and those of the stacking positioning convex portions 304 correspond to each other, and when the memory cartridges 3 are stacked on each other, the stacking positioning convex portions 304 of the memory cartridge 3 located above are inserted into the stacking positioning concave portions 303 of the memory cartridge 3 located immediately below. With this, the positions of the stacked memory cartridges 3 are fixed.

An upper non-slip portion 305 is formed on the upper case 301. Further, a lower non-slip portion 306 is formed on the bottom surface of the lower case 302. Each of the upper non-slip portion 305 and the lower non-slip portion 306 has many fine asperities, which prevent the memory cartridge 3 from slipping from the hand of a user when the user pulls out the memory cartridge 3 from the rack, for example.

Further, a plurality of notch portions 307 are formed over the bottom surface and the side surfaces of the lower case 302. The notch portions 307 are used for positioning the memory cartridge 3 when being accommodated in the rack or for fixing the memory cartridge 3 within the rack in a stable state.

A communication opening 308 is provided in the front side surface of the memory cartridge 3. A cable that connects the memory cartridge 3 and the waveguide 4 serving as a bus is inserted into the communication opening 308.

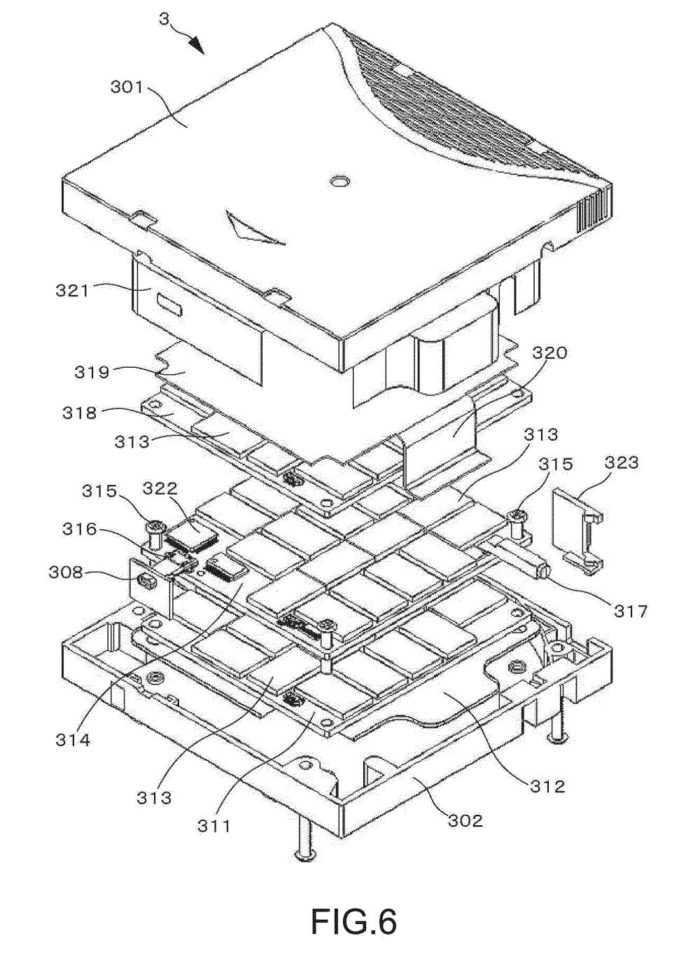

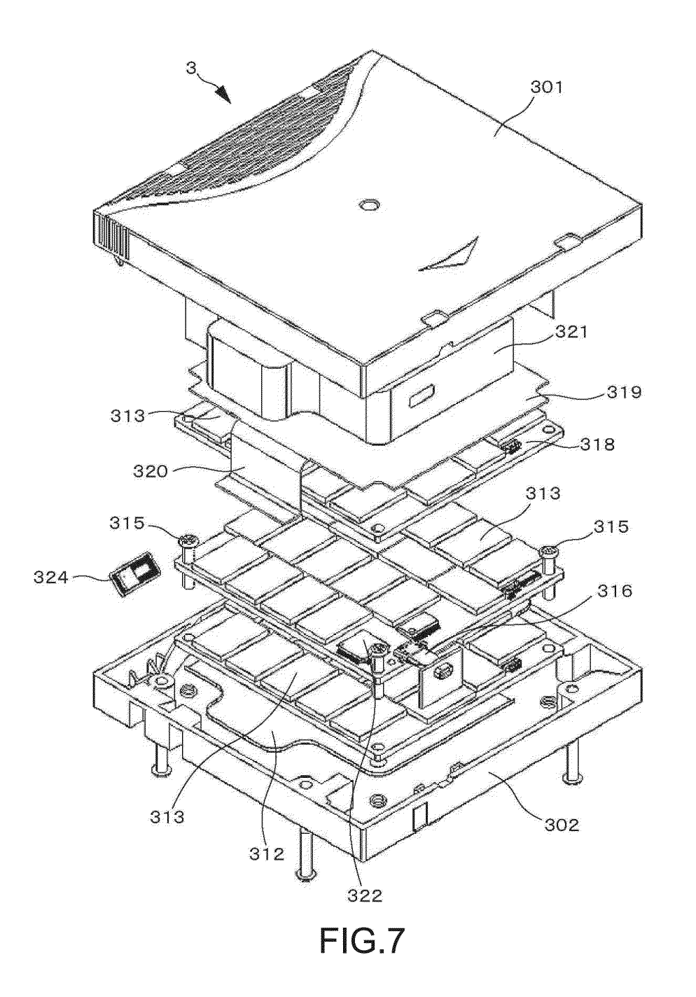

FIG. 6 is an exploded view of the memory cartridge 3. Further, FIG. 7 is an exploded view of the memory cartridge 3 when seen from an angle different from that of FIG. 6.

Provided in the memory cartridge 3 are a lower substrate 311, a lower unnecessary radiation shield 312, non-volatile semiconductor memories 313, an intermediate substrate 314, an optical conversion lens for auxiliary power 317, an upper substrate 318, a heat radiation sheet 319, an upper unnecessary radiation shield 321, a circuit unit 322, a Rec/UnRec switch (erroneous deletion preventing switch) 323, a non-contact tag RFID (Radio Frequency Identification) 324, and a battery cell.

The lower substrate 311 is provided on the bottom side within the memory cartridge 3. The lower unnecessary radiation shield 312 is provided on the lower surface of the lower substrate 311. The unnecessary radiation is unnecessary radio waves, electromagnetic waves, and an electromagnetic field generated due to a sharp change in current or voltage in an electronic apparatus, for example, and has a possibility of causing an error operation of a surrounding electronic apparatus or imparting noise to data, signals, and the like. The lower unnecessary radiation shield 312 is made of predetermined metal, for example, copper or nickel, and is provided to prevent the unnecessary radiation thereof.

The plurality of non-volatile semiconductor memories 313 are provided on the lower substrate 311. The non-volatile semiconductor memories 313 store various types of data.

Above the lower substrate 311, the intermediate substrate 314 is provided by being supported by a plurality of substrate screws 315. The non-volatile semiconductor memories 313 are provided on the intermediate substrate 314. The non-volatile semiconductor memories 313 are the same as those provided on the lower substrate 311.

A cartridge-side connector 316 for connecting the memory cartridge 3 and the waveguide 4 is provided on the intermediate substrate 314. The connection between the memory cartridge 3 and the waveguide 4 will be described later. Further, the optical conversion lens for auxiliary power 317 is provided to the intermediate substrate 314.

Above the intermediate substrate 314, the upper substrate 318 is provided by being supported by the plurality of substrate screws 315. The non-volatile semiconductor memories 313 are provided on the upper substrate 318. The non-volatile semiconductor memories 313 are the same as those provided on the lower substrate 311 and the intermediate substrate 314.

Furthermore, the heat radiation sheet 319 is provided on the upper substrate 318. The heat radiation sheet 319 includes a pair of leg portions 320 and is provided to stand up with the leg portions 320 on the lower unnecessary radiation shield 312. Heat generated in the memory cartridge 3 is transmitted to the heat radiation sheet 319 and radiated from the heat radiation sheet 319.

The upper unnecessary radiation shield 321 is provided on the inner surface side of the upper case 301. The upper unnecessary radiation shield 321 is made of predetermined metal such as copper or nickel, like the lower unnecessary radiation shield 312 described above, and is provided to prevent the unnecessary radiation thereof.

Further, within the memory cartridge 3, the circuit unit 322 that performs processing to serve as a power-supply control unit, a memory controller, and the like is provided. Furthermore, the Rec/UnRec switch 323 is provided within the memory cartridge 3.

Additionally, as shown in FIG. 7, the non-contact tag RFID 324 is provided within the memory cartridge 3. The non-contact tag RFID 324 stores identification data unique to the individual memory cartridge 3, communicates with a readout apparatus or the like by the non-contact communication technology, and identifies the individual memory cartridge 3. Though not shown in the figures, a battery cell for supplying power to the memory cartridge 3 is also provided within the memory cartridge 3.

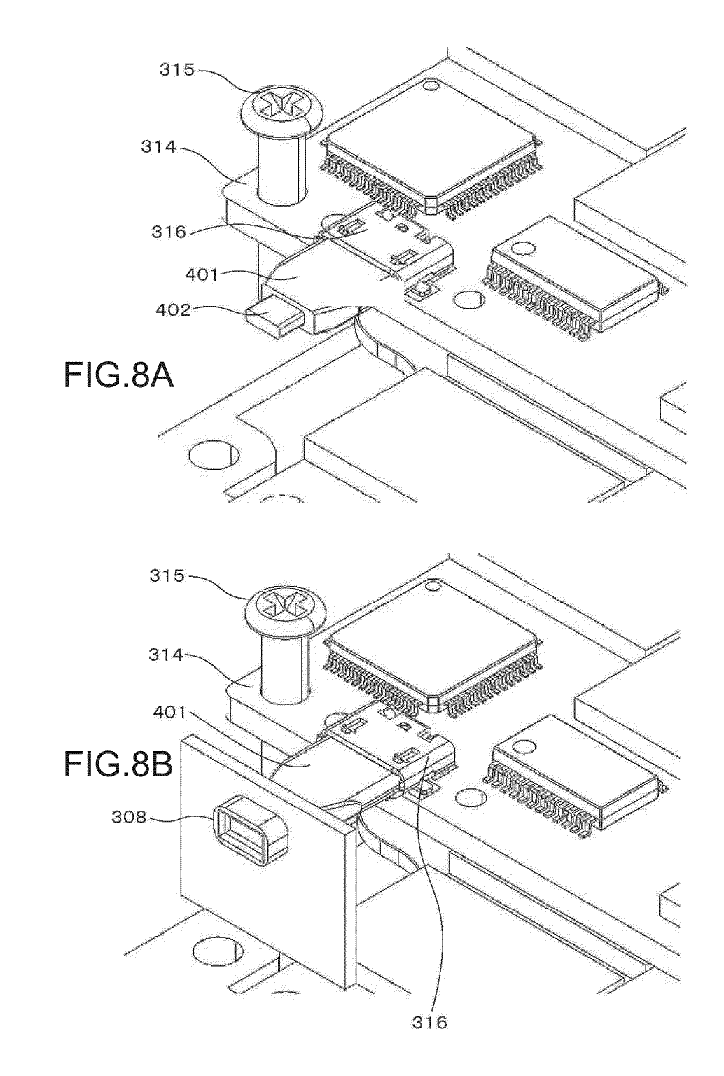

FIGS. 8A and 8B are enlarged views of the vicinity of the cartridge-side connector 316 on the intermediate substrate 314. A cable-side connector 401 is connected to the cartridge-side connector 316. The cable-side connector 401 is provided to one end of a cable 402.

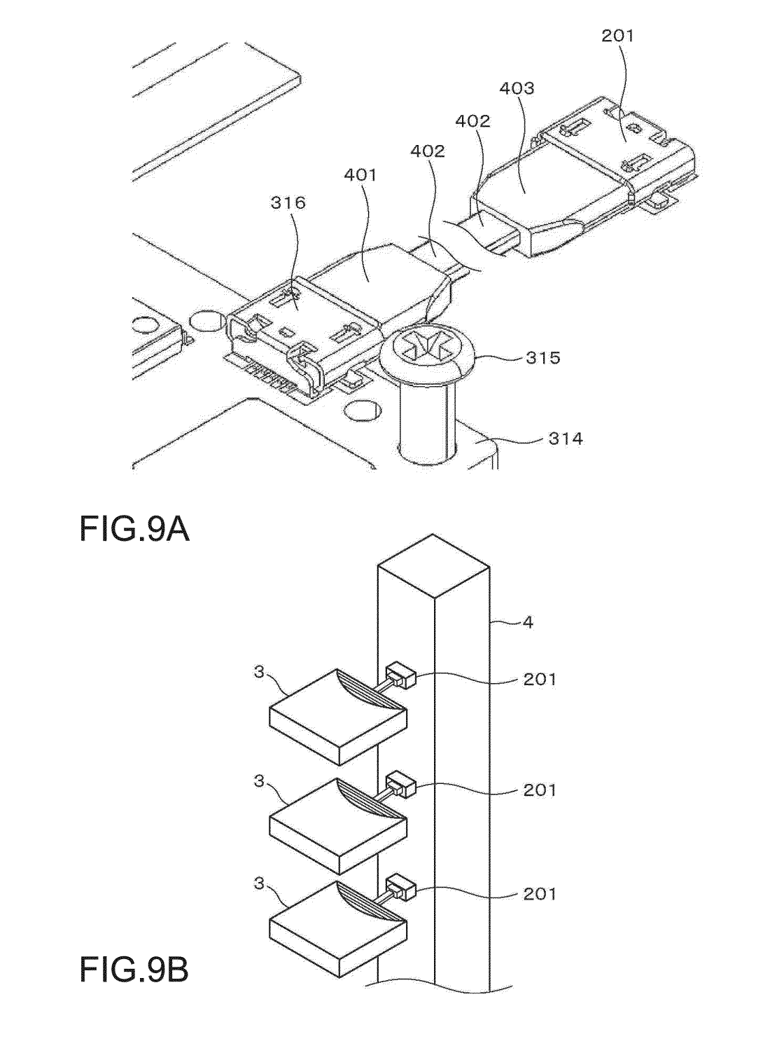

As shown in FIG. 9A, a cable-side connector 403 provided to the other end of the cable 402 is connected to a waveguide-side connector 201 provided to the waveguide 4 serving as a bus. As shown in FIG. 9B, a plurality of waveguide-side connectors 201 are provided to a side surface of the waveguide 4 in a vertical direction of the waveguide 200.

It should be noted that the cable-side connector 401 and the cartridge-side connector 316 do not have an electric contact and the connector portion has only a function as alignment. In the same manner, the cable-side connector 403 and the waveguide-side connector 201 also do not have an electric contact and the connector portion has only a function as alignment. Communication is performed by wireless communication with an antenna for microwaves or millimeter waves in the connector. So, the communication does not cause troubles due to corrosion, deterioration, and the like of the electric contacts.

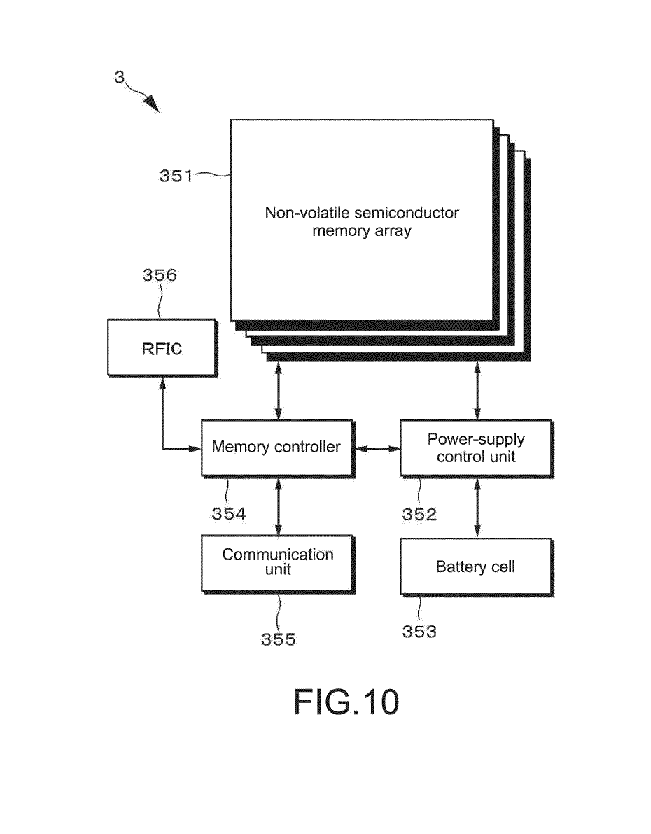

FIG. 10 is a functional block diagram of the memory cartridge 3. The memory cartridge 3 includes a non-volatile semiconductor memory array 351, a power-supply control unit 352, a battery cell 353, a memory controller 354, a communication unit 355, and an RFIC (Radio Frequency Integrated Circuit) 356.

The non-volatile semiconductor memory array 351 includes a plurality of non-volatile semiconductor memories. The non-volatile semiconductor memory array 351 stores various types of data.

The battery cell 353 is a power source that supplies power to the memory cartridge 3. The power-supply control unit 352 is a control unit that performs power-supply control in which power from the battery cell 353 is supplied to each unit of the memory cartridge 3.

The memory controller 354 performs data-write processing and data-readout processing on the non-volatile semiconductor memory array 351. The memory controller 354 may further perform error detection and correction processing and the like in units of access.

The communication unit 355 includes a TX module and an RX module and communicates with the waveguide 4 serving as a bus.

The RFIC 356 has a function of performing communication in a non-contact state. The RFIC 356 executes processing of receiving, by an antenna, radio waves or magnetic field output by a reader/writer serving as the other party of communication and converting them into power to output an ID (Identification Information) or the like stored in the memory to the reader/writer, or outputting data input from the outside to the memory controller 354, and the like. Further, the RFIC 356 may have a data processing function such as authentication processing using identification information such as an ID.

It should be noted that the power-supply control unit 352 and the memory controller 354 may be achieved by execution of a predetermined program by the circuit unit, for example. Further, the power-supply control unit 352 and the memory controller 354 may be achieved by not only a program but also a combination of dedicated circuits of hardware having respective functions, for example.

As described above, the memory cartridge 3 is configured.

### 1-3. Connection Between Bus and Recording Apparatus

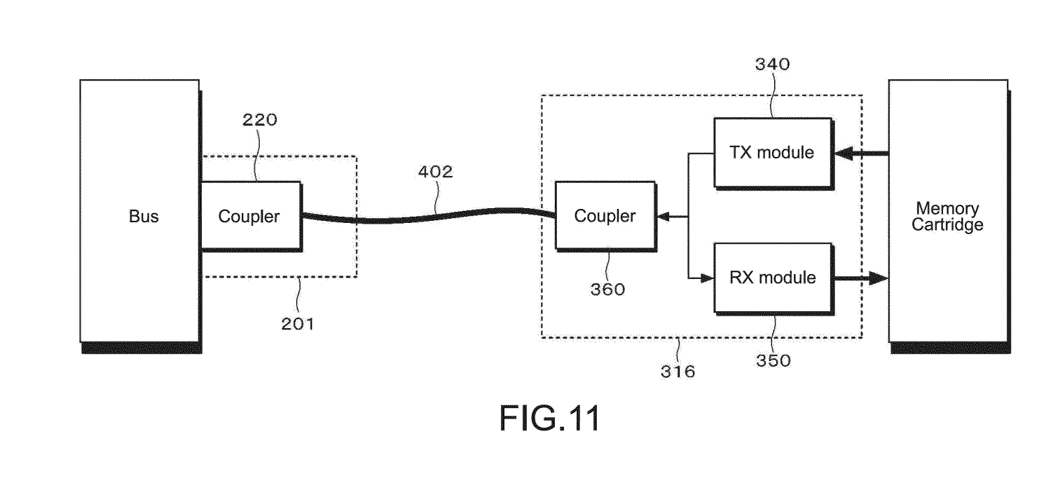

Next, description will be given on connection between the waveguide 4 serving as a bus and the memory cartridge 3 serving as a recording apparatus. FIG. 11 is a block diagram showing a connection state of the waveguide-side connector 201 provided to the waveguide 4 and the cartridge-side connector 316 provided to the memory cartridge 3.

The waveguide-side connector 201 includes a millimeter-wave coupler 220. Further, the cartridge-side connector 316 includes a millimeter-wave coupler 360, a TX module 340, and an RX module 350. Furthermore, the waveguide-side connector 201 and the cartridge-side connector 316 are connected to each other with the cable 402.

Communication between the waveguide 4 serving as a bus and the memory cartridge 3 connected to the waveguide 4 is performed via the waveguide-side connector 201, the cable 402, and the cartridge-side connector 316.

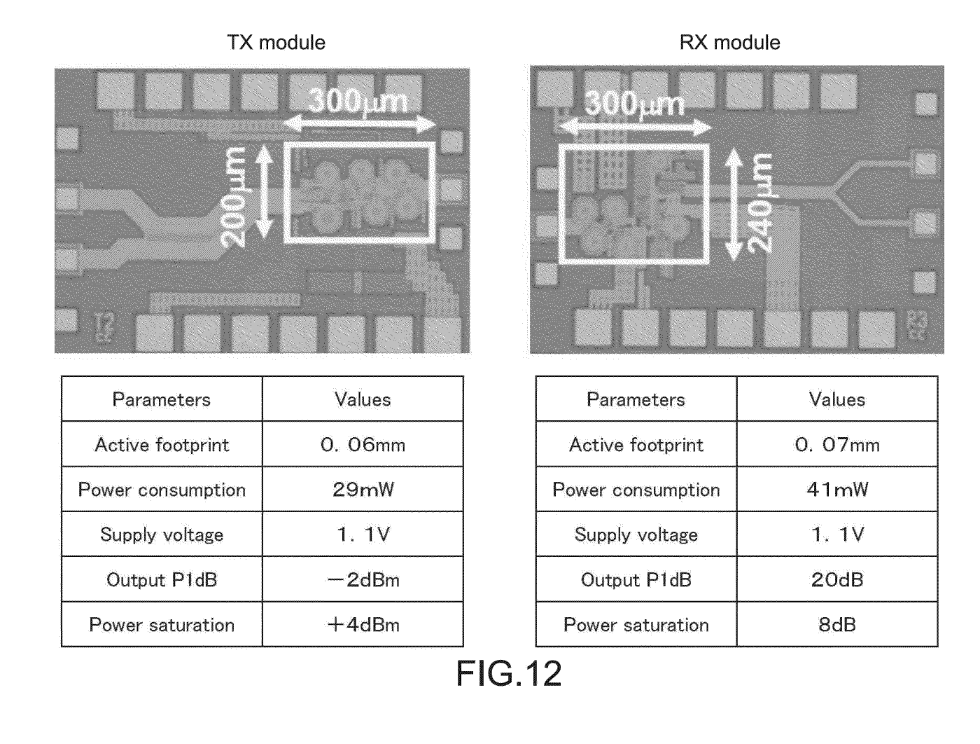

The specifications of the TX module and the RX module are as shown in FIG. 12, for example. It should be noted that the specifications of the TX module and the RX module are not limited to those of FIG. 12. The TX module and the RX module are each formed of a CMOS (Complementary Metal Oxide Semiconductor), for example.

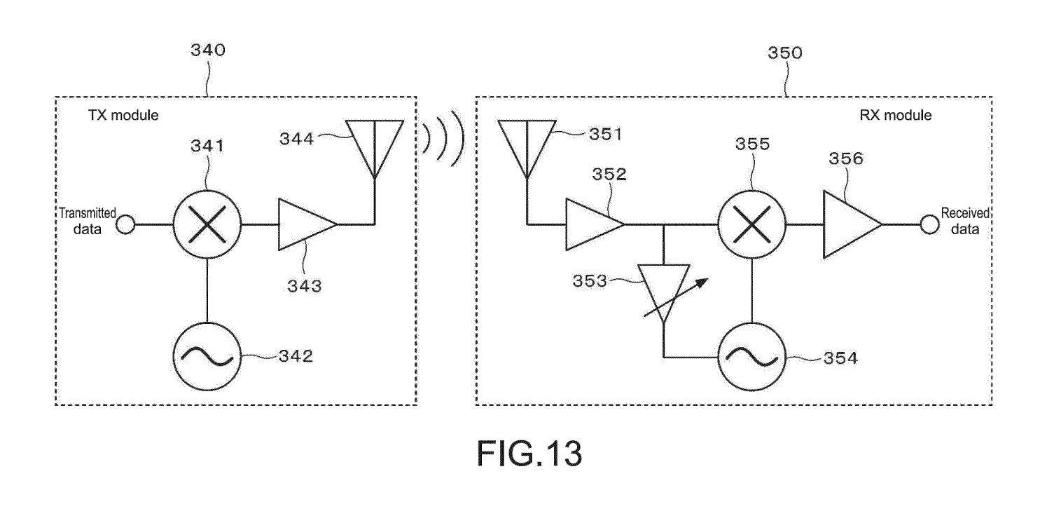

FIG. 13 is a diagram showing a configuration of the TX module 340 and the RX module 350 in the cartridge-side connector 316. The TX module 340 includes a multiplier 341, a local oscillator 342, an amplifier 343, and an antenna 344. Meanwhile, the RX module 350 includes an antenna 351, a first amplifier 352, a variable gain amplifier 353, a local oscillator 354, a multiplier 355, and a second amplifier 356.

Data acquired from the memory cartridge 3 is multiplied by a local oscillation signal (of 60 GHz, for example) from the local oscillator 342 by the multiplier 341 in the TX module 340 and is further amplified by the amplifier 343. Subsequently, the data is transmitted, as a signal, from the antenna 344 to the millimeter-wave coupler 360.

A signal transmitted from the waveguide 4 is received by the antenna 351 of the RX module 350 and is subsequently amplified by the first amplifier 352. Next, the resultant signal is supplied to the local oscillator 354 via the variable gain amplifier 353. After a multiplication by a local oscillation signal (of 60 GHz, for example) is performed in the multiplier 355, the resultant signal is amplified by the second amplifier 356 to be output as received data.

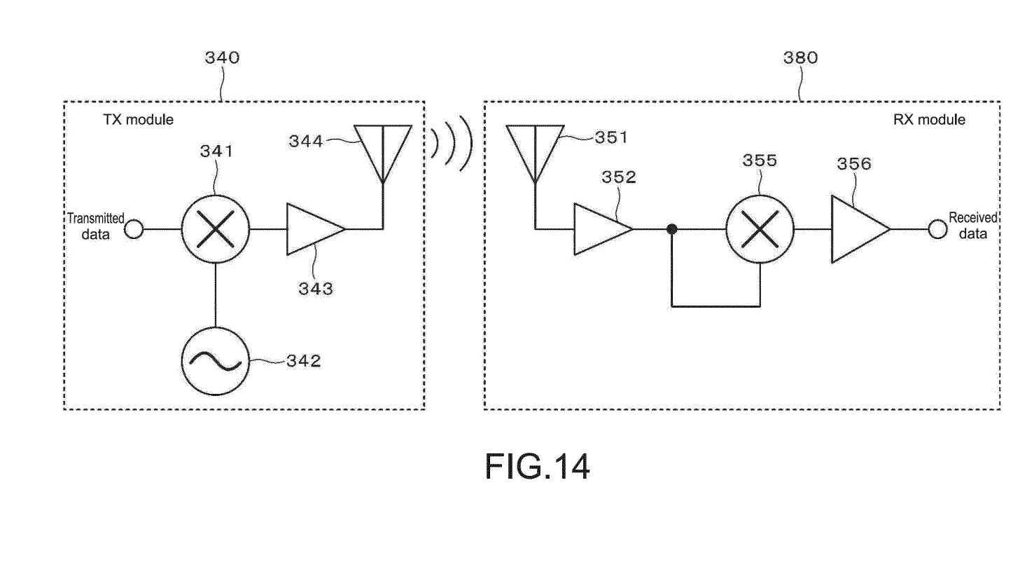

Note that the TX module 340 and the RX module 350 are not limited to the configurations shown in FIG. 13. FIG. 14 shows a second example of the configurations of the TX module and the RX module. It should be noted that the TX module 340 is the same as that of the first example shown in FIG. 13, and description thereof will be omitted.

An RX module 380 includes an antenna 351, a first amplifier 352, a multiplier 355, and a second amplifier 356. Data transmitted from the TX module 340 is received by the antenna 351 of the RX module 380 and is subsequently amplified by the first amplifier 352. Next, the data is supplied to the second amplifier 356 via the multiplier 355, amplified by the second amplifier 356, and output as received data.

The signal is multiplied by the square of the signal in the RX module 380, and thus the RX module can be formed without using the local oscillator. With this configuration, the number of components of the RX module can be reduced. It should be noted that the first example of the RX module shown in FIG. 13 is more excellent in performance than the second example of the RX module shown in FIG. 14.

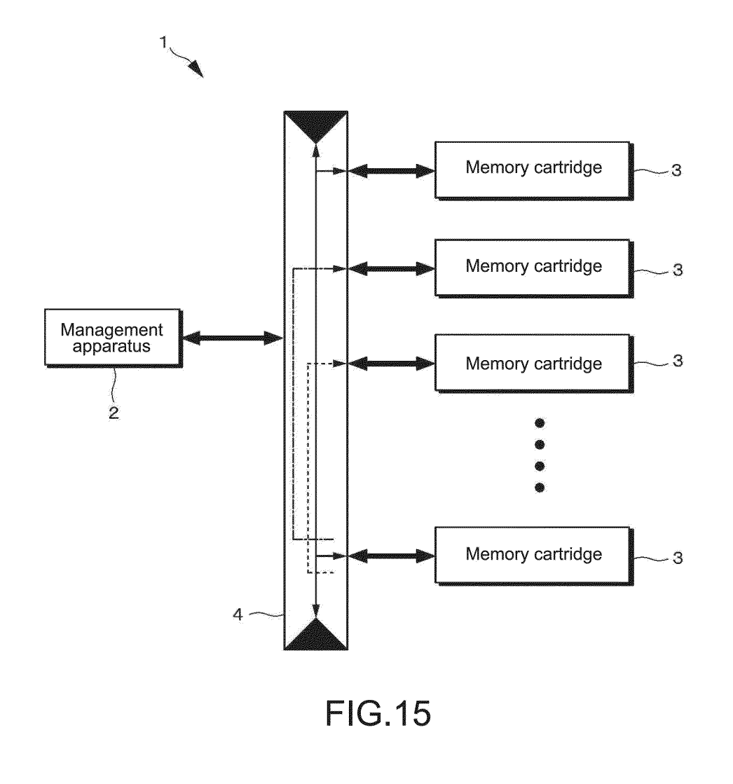

FIG. 15 is a diagram showing the outline of communication between the waveguide 4 and the memory cartridges 3 when using a plurality of frequencies. As described above, in the present disclosure, wireless communication using the microwaves or millimeter waves is performed by the waveguide 4 serving as a bus. In FIG. 15, the plurality of memory cartridges 3 are connected to the waveguide 4 by wireless communication.

In the wireless communication using the microwaves or millimeter waves, as shown in FIG. 15, a plurality of frequencies can be used in communication between the waveguide 4 and the memory cartridges 3. For example, the waveguide 4 and a memory cartridge 3 are connected by using a first frequency. Further, another memory cartridge 3, which is different from the memory cartridge 3 connected using the first frequency, is connected to the waveguide 4 by using a second frequency. In FIG. 15, an alternate long and short dash line indicates a connection by the first frequency, and a dotted line indicates a connection by the second frequency. In the case of using millimeter waves for communication, a frequency of 60 GHz can be used as the first frequency for example, and a frequency of 80 GHz can be used as the second frequency for example.

By the control of the management apparatus 2, a frequency to be used for communication is switched from the first frequency to the second frequency, for example. In this case, the memory cartridge 3 capable of communicating is switched from the memory cartridge 3 connected by the first frequency to the memory cartridge 3 connected by the second frequency. In such a manner, the memory cartridges 3 that perform communication can be switched as if a cable connection is switched.

Further, in the case where the plurality of frequencies are used in communication between the waveguide 4 and the memory cartridges 3, it may be possible not to perform communication by selecting any one of the frequencies but to simultaneously perform communication between the waveguide 4 and the memory cartridges 3 at the plurality of frequencies.

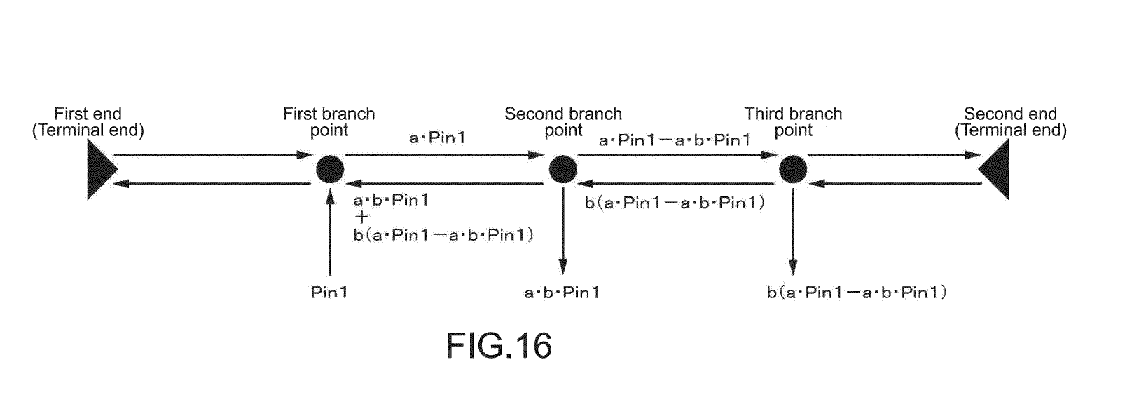

In the case where the waveguide is used as a transmission path for communication, it is necessary to terminate the flow of an electric field in the waveguide in order to prevent the leakage, reflection, and the like of radio waves. FIG. 16 is a diagram schematically showing a state where the waveguide 4 is terminated. For convenience of the description, both the ends of the waveguide 4 are referred to as a first end and a second end, respectively. The first end and the second end are subjected to a termination process. Further, branch points are referred to as a first branch point, a second branch point, and a third branch point.

An input to the waveguide 4 is assumed as Pin1. The input Pin1 becomes “a•Pin1” by a coefficient a via the first branch point and directed to the second branch point.

In the second branch point, “a•Pin1” becomes “a•b•Pin1” by a coefficient b and is output from the second branch point. Further, a difference “a•Pin1-a•b•Pin1” between “a•Pin1” and “a•b•Pin1”, which is the output from the second branch point, is directed to the third branch point.

In the third branch point, “b(a•Pin1-a•b•Pin1)” multiplied by a coefficient b is output. As described above, since the ends of the waveguide are subjected to a termination process, there is no reflection or leakage from the second end, and “b(a•Pin1-a•b•Pin1)” equal to the output from the third branch point is directed to the second branch point.

In the second branch point, a sum of “a•b•Pin1” and “b(a•Pin1-a•b•Pin1)”, that is, “a•b•Pin1+b(a•Pin1-a•b•Pin1)” is directed to the first branch point. As described above, since the ends of the waveguide are subjected to a termination process, there is no reflection or leakage of radio waves from the first end.

Further, there is a technique of preventing leakage and reflection of radio waves in the waveguide 4 by forming a wall made of conductive body with use of a transparent conductor. Conductors to be used are ones shown in Table 1 below, for example. It is possible to make a choice such as using ITO (Indium Tin Oxide) in the case of an individual piece, and using Sheerflex (registered trademark) having flexibility if it is necessary to be folded back. It should be noted that the conductors to be used are not limited to those shown in Table 1.

TABLE 1

| | Conductivity | Transparency | Flexibility |
|---|---|---|---|
| Indium Tin Oxide | High | Yes | No |
| Silver Conductive Inks | Yes | No | No |
| Graphene Inks | Medium | No | No |
| Sheerflex | Medium | Yes | Yes |

As described above, the data bus system 1 according to the embodiment of the present disclosure is formed. According to the present disclosure, data transmission and reception between the waveguide 4 and the memory cartridge 3 is performed by wireless communication. Consequently, it is possible to achieve a data bus system that does not cause unavailability of communication due to deterioration and the like of a contact of a connector and does not cause failures in communication.

### 2. Modified Example

Hereinabove, the embodiment of the present disclosure has been specifically described, but the present disclosure is not limited to the embodiment described above and can be variously modified based on the technical idea of the present disclosure. The present disclosure can have the following configurations.

(1) A data bus system, including:

a plurality of recording apparatuses configured to record and hold data;

a transmission path connected to the plurality of recording apparatuses by wireless communication and configured to transmit the data; and

a management apparatus configured to manage states of the plurality of recording apparatuses and the transmission path.

(2) The data bus system according to (1), in which

the transmission path includes a waveguide.

(3) The data bus system according to (1) or (2), in which

the plurality of recording apparatuses and the transmission path communicate with each other in a microwave band.

(4) The data bus system according to (1) or (2), in which

the plurality of recording apparatuses and the transmission path communicate with each other in a millimeter-wave band.

(5) The data bus system according to any one of (1) to (4), in which

the plurality of recording apparatuses and the transmission path communicate with each another at a plurality of frequencies.

(6) The data bus system according to any one of (1) to (5), in which

the plurality of recording apparatuses include a recording apparatus that performs communication at one of the plurality of frequencies and a recording apparatus that performs communication at a frequency different from the one frequency, and

the management apparatus is configured to select a frequency to be used for communication from the plurality of frequencies, to switch the recording apparatus of a communication target.

(7) The data bus system according to any one of (1) to (5), in which

the plurality of recording apparatuses and the transmission path can simultaneously communicate with each other at the plurality of frequencies.

(8) The data bus system according to any one of (1) to (7), further including a rack configured to store the plurality of recording apparatuses.

(9) The data bus system according to (8), in which

the waveguide that forms the transmission path is provided to the rack.

(10) The data bus system according to (8) or (9), in which

each of the plurality of recording apparatuses includes a memory cartridge that can be accommodated in the rack.

(11) A recording apparatus, including:

a recording unit configured to record and hold data;

a communication unit configured to wirelessly communicate with an external transmission path; and

a memory controller configured to control input and output of the data to and from the recording unit.

What is claimed is:

1. A data bus system, comprising:
a plurality of recording apparatuses configured to record and hold data;
a transmission path connected to the plurality of recording apparatuses by wireless communication and configured to transmit the data; and
a management apparatus configured to manage the plurality of recording apparatuses and the transmission path.

2. The data bus system according to claim 1, wherein
the transmission path includes a waveguide.

3. The data bus system according to claim 1, wherein
the plurality of recording apparatuses and the transmission path communicate with each other in a microwave band.

4. The data bus system according to claim 1, wherein
the plurality of recording apparatuses and the transmission path communicate with each other in a millimeter-wave band.

5. The data bus system according to claim 1, wherein
the plurality of recording apparatuses and the transmission path communicate with each another at a plurality of frequencies.

6. The data bus system according to claim 5, wherein
the plurality of recording apparatuses include a recording apparatus that performs communication at one of the plurality of frequencies and a recording apparatus that performs communication at a frequency different from the one frequency, and
the management apparatus is configured to select a frequency to be used for communication from the plurality of frequencies, to switch the recording apparatus of a communication target.

7. The data bus system according to claim 5, wherein
the plurality of recording apparatuses and the transmission path can simultaneously communicate with each other at the plurality of frequencies.

8. The data bus system according to claim 1, further comprising a rack configured to store the plurality of recording apparatuses.

9. The data bus system according to claim 8, wherein
the waveguide that forms the transmission path is provided to the rack.

10. The data bus system according to claim 8, wherein
each of the plurality of recording apparatuses includes a memory cartridge that can be accommodated in the rack.

11. A recording apparatus, comprising:
a recording unit configured to record and hold data;
a communication unit configured to wirelessly communicate with an external transmission path; and
a memory controller configured to control input and output of the data to and from the recording unit.
